(19) United States
(12) Patent Application Publication
(10) Pub. No.: US 2004/0198429 A1
(43) Pub. Date: Oct. 7, 2004

(54) Hub provided with function of wireless communication

(76) Inventors: An-Yu Yen, Hsinchu (TW); Fu Chi Chuang, Hsinchu (TW); Chia-Ling Chang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/227,824

(22) Filed: Aug. 27, 2002

(51) Int. Cl. H04B 1/38

(52) U.S. Cl. 455/556.1; 455/561

(57) ABSTRACT

The present invention generally relates to provide a hub provided with a function of built-in wireless communication. The hub comprises a hub control module and a wireless communication module. The hub control module can provide one upstream port and a plurality of downstream ports for individually connecting with the computer and a plurality of USB peripheral devices, or can provide a plurality of network connection ports for connecting with the network devices. The wireless communication module is connecting with the hub control module. The wireless communication module can be a bluetooth communication module or the wireless network communication module, so as the hub can be provided with the function of wireless communication. The present invention can be convenient for users assembling the hub simultaneously provided with the function of bluetooth or wireless network and to achieve the advantage of high convenience and provide the advantage of saving more space for arranging other peripheral equipments.

### BACKGROUND OF THE INVENTION

1. Field of the Invention

The present invention generally relates to provide a hub, and more particularly relates to a hub provided with built-in wireless communication function.

2. Description of the Prior Art

With the highly development of the information technology (IT) industry, the use of the internet and the personal computer not only cause the information circulating speedily and shortening the visible distance between different regions. Recently, with the rising and flourishing development of the wireless communication technology, the wireless local area network (LAN) technology is integrated within the common computer equipments or communication devices to achieve the data transmitting via the connection between the wireless transmitting and the Internet in a short distance and can reduce the un-convenience and high cost causing from the numerous cable lines of the wiring of the prior network. However, the development of the bluetooth technology makes the transmitting of the prompt voice and information more convenient so as to enhance the mobile equipments, such as the mobile phone, the wireless phone, the notebook computer, the personal digital assistant (PDA), the digital camera, the printer, and the local area network (LAN), and etc., to connect each other and transfer data via the electric wave of the bluetooth system.

Within the normal computer peripheral equipments, the hub is a indispensable equipment, wherein the USB hub 10 is a box type substance assembling with a plurality of the connection ports 12, such as shown in the FIG. 1, so as the connection ports 12 of the USB hub 10 to provide the connection between the computer host 14 and a plurality of USB peripheral equipments 16. However, another type network hub is mainly utilized in the Ethernet network, the network hub usually provides a plurality of RJ45 ports so as to form a structured network architecture via the connection between the cable lines and the network devices.

However, no matter in the USB hub or in the network hub mentioned above, if the users would like to use the function of wireless communication, they need add a wireless communication equipment 18 having the function of wireless communication, such as the wireless local area network adapter (WLAN adapter), the bluetooth USB receive/transmit module, or etc., on the one connection port of the USB hub or one RJ 45 port of the network hub. It not only causes the un-convenience of assembling the equipment and the un-convenience of taking the equipment along with the users, but also become a waste of the connection ports or pins for the limited amount of the connection ports or pins of the hub.

Obviously, the main spirit of the present invention is to provide a hub provided with built-in wireless communication function, and then some disadvantages of well-known technology are overcome.

### SUMMARY OF THE INVENTION

The primary object of the present invention is to provide a hub provided with built-in wireless communication function in order to be convenient for users assembling the hub simultaneously provided with the function of bluetooth or wireless network and to achieve the advantage of high convenience.

Another object of the present invention is to provide a hub, which is built-in the function of bluetooth or wireless network. In the present invention, the users would not waste one connection port on the hub because of the require of adding another wireless network equipments on the hub, but also the present invention can provide the advantage of saving more space for arranging other peripheral equipments.

In order to achieve previous objects, a hub provided with a function of wireless communication of the present invention comprises a hub control module, which is for connecting the USB peripheral equipments or connecting the network devices, and a wireless communication module, which is connecting with the hub control module and built-in the hub to provide the function of wireless communication of the hub.

Other aspects, features, and advantages of the present invention will become apparent, as the invention becomes better understood by reading the following description in conjunction with the accompanying drawings.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic representation of the relation between the universal serial bus (USB) hub and the wireless network equipments, in accordance with prior techniques;

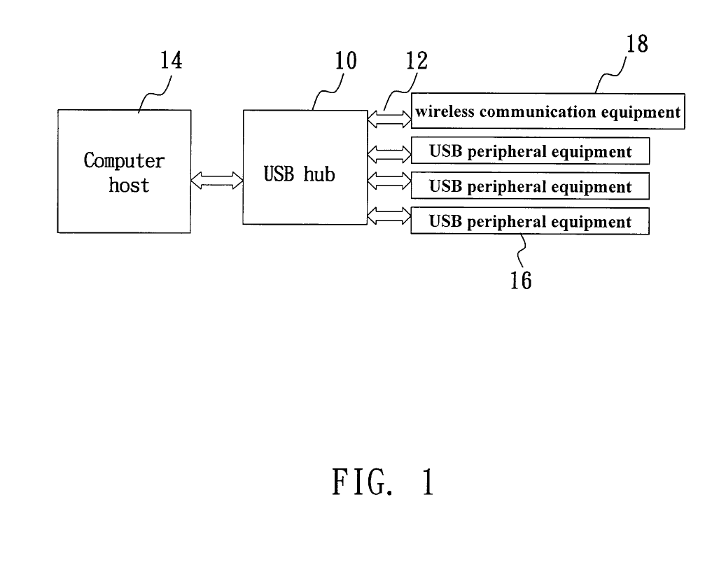

FIG. 2 is a schematic representation of the relation between the universal serial bus (USB) hub and the universal serial bus (USB) wireless network equipments, in accordance with the present invention; and

FIG. 3 is a schematic representation of the relation between the network hub and the network equipment, in accordance with the present invention.

### DESCRIPTION OF THE PREFERRED EMBODIMENT

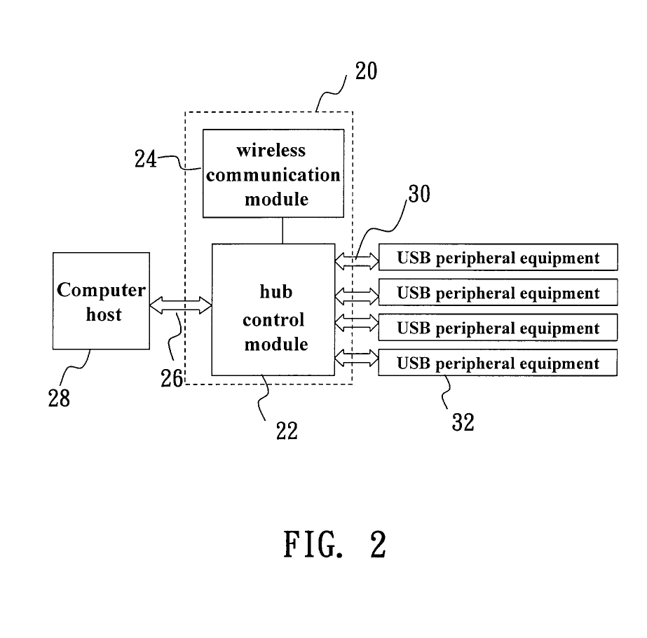

Referring to the FIG. 2, the hub 20 includes a hub control module 22 and a wireless communication module 24. Take the USB host for an example, the hub control module 22 provides an upstream port 26 to connect a computer host 28 and a plurality of downstream ports 30 for the users connecting any other USB peripheral equipments 32, such as the keyboard, the mouse, the color scanner, the digital camera, digital video camera, the trumpet equipment, and etc. The wireless communication module 24 is connected with the hub control module 22 for providing the computer host 28 with a function of wireless communication.

Wherein, the wireless communication module 24 can be a bluetooth communication module or a wireless network communication module so as to make the computer perform the wireless communication via the wireless network module 24 and the connection equipment of the external wireless network and then connect to the Internet to proceed the function of network communications, such as the network chatting, the video/audio show seeing, the on-line game, the data searching and transmitting, the e-mail receiving, and etc.

In the present invention, owing to the hub 20 has already built-in a wireless communication module 24, so the users would not need to add another wireless communication equipments, such as the wireless local area network adapter (WLAN adapter), the bluetooth USB receive/transmit module, or etc., and can achieve the function of wireless internet accessing via the communication between the wireless communication module 24 of the hub 20 and the connection equipment of wireless network. The present invention not only provides the convenience without assembling the equipment and taking the equipment along with the users, but also the users would not waste one USB downstream port on the hub for adding another wireless network equipments on the hub. So, the present invention saves one downstream port 30 of the hub 20 to save more space of the hub 10 and provide the advantage of providing more space for arranging other USB peripheral equipments 32.

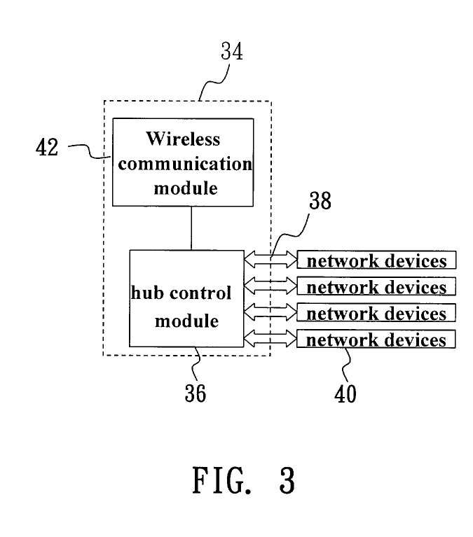

On the other hand, the hub of the present invention can also be a network hub 34, such as shown in the FIG. 3. The inside arrangement of the hub control module 36 provides a plurality of network connection ports, such as the RJ45 connection port 38, to connect the network devices 40, such as the computer, network printer, or the network hub. However, the network hub 34 is also built-in a wireless communication module 42, which is connecting with the hub control module 36, to provide the network hub 34 with a function of connecting the external network equipments, so as the network equipment 40 mentioned above can be provided with the function of wireless network communication via the network hub 34.

Of course, it is to be understood that the invention described herein need not be limited to these disclosed embodiments. Various modification and similar changes are still possible within the spirit of this invention. In this way, all such variations and modifications are included within the intended scope of the invention and the scope of this invention should be defined by the appended claims.

What is claimed is:

1. A hub provided with a function of wireless communication, said hub comprising:
a hub control module; and
a wireless communication module, wherein said wireless communication module is connecting with said hub control module to provide said function of wireless communication.

2. The hub according to claim 1, wherein said hub control module provides at least one universal serial bus (USB) upstream port for connecting with a computer host and provides at least one universal serial bus (USB) downstream port for connecting at least one universal serial bus (USB) peripheral equipment.

3. The hub according to claim 1, wherein said hub control module provides a plurality of network connection ports for connecting with at least one network device.

4. The hub according to claim 3, wherein said network connection port is an RJ45 connection port.

5. The hub according to claim 3, wherein said network device can be selected from the group of computer, network printer, and network hub.

6. The hub according to claim 1, wherein said wireless communication module can be selected from the group of bluetooth wireless communication module and wireless network communication module.
